(19) United States
(12) Patent Application Publication
(10) Pub. No.: US 2019/0157024 A1
(43) Pub. Date: May 23, 2019

(54) CAPPED KEYBOARD APPARATUS

(71) Applicant: Acrox Technologies Co., Ltd., Taipei (TW)

(72) Inventor: Steve Ore-Yang, Taipei (TW)

(73) Assignee: Acrox Technologies Co., Ltd., Taipei (TW)

(21) Appl. No.: 16/036,114

(22) Filed: Jul. 16, 2018

(30) Foreign Application Priority Data
Nov. 23, 2017 (TW) 106140801

(51) Int. Cl. H01H 13/86; H01H 13/88; G06F 3/02

(52) U.S. Cl. CPC H01H 13/86; H01H 13/702; G06F 3/0202; H01H 13/88

(57) ABSTRACT

A capped keyboard apparatus is disclosed. The proposed capped keyboard apparatus includes plural independent keycaps, wherein each the keycap has a main body, and a cover layer covering the main body and including a shell fabric layer and a base material layer attached to the shell fabric layer, wherein a character is formed on an upper surface of the shell fabric layer, and a light emitted out from an interior of the capped keyboard apparatus is scattered uniformly because of the base material layer.

### CROSS-REFERENCES TO RELATED APPLICATIONS

This application claims the benefits of Taiwan Patent Application Number 106140801 filed on Nov. 23, 2017, at the Taiwan Intellectual Property Office, the disclosures of which are incorporated herein in their entirety by reference.

### FIELD OF THE INVENTION

The present invention relates to a capped keyboard apparatus, in particular to a backlit keyboard including plural independent keycaps and plural independent cover layers.

### BACKGROUND OF THE INVENTION

The backlit keyboards in the prior art are frequently adapted for use with notebook computers. When a backlit keyboard starts the backlight function in a dark place, the white LEDs inside the keyboard will emit a light and penetrate through the laser-carved character upon each keycap so that the characters on the keyboard can be seen clearly by the user. When in a bright place, the LEDs in the backlit keyboard will be turned off to save power. Thus, the backlit keyboard is good for operating at night or in a dark place. In contrast, a light cannot be emitted out from a non-backlit keyboard. However, in order to let characters formed by laser carving be penetrated by light and to prevent other parts of the keycap from being penetrated by light in a backlit keyboard, the keycap main body needs to be baked and varnished for up to as many as 10 layers so that no light can penetrate through and also be abrasion resistant. And then, the baking paint located upon the character on an upper surface of the keycap is removed by laser carving so that a light can be emitted out from the character.

However, the manufacturing procedure for baking and varnishing up to as many as 10 layers on the keycap main body involves a long manufacturing time and has high costs. Thus, how to improve this manufacturing procedure in the prior art to save the relative manufacturing costs and time and to cause a light emitted out from the character to be uniformly distributed are important aspects for development in the field.

Keeping the drawbacks of the prior art in mind, and through the use of robust and persistent experiments and research, the applicant has finally conceived of a capped keyboard apparatus.

### SUMMARY OF THE INVENTION

It is an objective of the present invention to provide a capped keyboard apparatus with each of the plural keycaps configured on the keyboard having a relatively better texture and appearance than that of the keyboard apparatus in the prior art, and the relative manufacturing costs of the proposed keyboard is relatively lower than that of the backlit keyboard in the prior art because no baking varnish is required, the relative manufacturing time of the proposed keyboard is shorter than that of the backlit keyboard in the prior art, and a light emitted out from the character of the proposed keyboard is uniformly distributed.

In accordance with the first aspect of the present invention, a capped keyboard apparatus comprises plural independent keycaps, each of which includes a main body, and a cover layer covering the main body and including a shell fabric layer and a base material layer attached to the shell fabric layer, wherein a character is formed on an upper surface of the shell fabric layer, the base material layer includes a transparent material and an opaque pigment, the opaque pigment is mixed with the transparent material in a specific mixing ratio to adjust a color of the character seen by a naked eye, and a light emitted out from an inner portion of the capped keyboard apparatus is in a status being one selected from a group consisting of being scattered, refracted and reflected due to the specific mixing ratio to form a uniform light band.

In accordance with the second aspect of the present invention, a capped keyboard apparatus comprises plural independent keycaps, each of which includes a main body, and a cover layer covering the main body and including a shell fabric layer and a base material layer which has an opaque pigment and a light diffuser having a mixing ratio and is attached to the shell fabric layer, wherein a character is formed on an upper surface of the shell fabric layer, and a light emitted out from the capped keyboard apparatus via the character is in a status being one selected from a group consisting of being scattered, refracted and reflected according to the mixing ratio so as to form a uniform light band.

In accordance with the third aspect of the present invention, a capped keyboard apparatus comprises plural independent keycaps, each of which includes a main body, and a cover layer covering the main body and including a shell fabric layer and a base material layer attached to the shell fabric layer, wherein a character is formed on an upper surface of the shell fabric layer, and a light emitted out from an interior of the cap-covered keyboard apparatus is in a status being one selected from a group consisting of being scattered, refracted and reflected and depending on the base material layer to form a uniform light band.

### BRIEF DESCRIPTION OF THE DRAWINGS

Other objectives, advantages and the efficacy of the present invention will be described in detail below taken from the preferred embodiments with reference to the accompanying drawings, in which:

FIG. 1 is a sectional view diagram of a keycap according to the preferred embodiment of the present invention.

FIG. 2 is a top view diagram of a keycap of a keyboard according to the preferred embodiment of the present invention.

### DETAILED DESCRIPTION OF THE PREFERRED EMBODIMENT

The present invention will now be described more specifically with reference to the following embodiments. It is to be noted that the following descriptions of the preferred embodiments of this invention are presented herein for purposes of illustration and description only; they are not intended to be exhaustive or to be limited to the precise form disclosed.

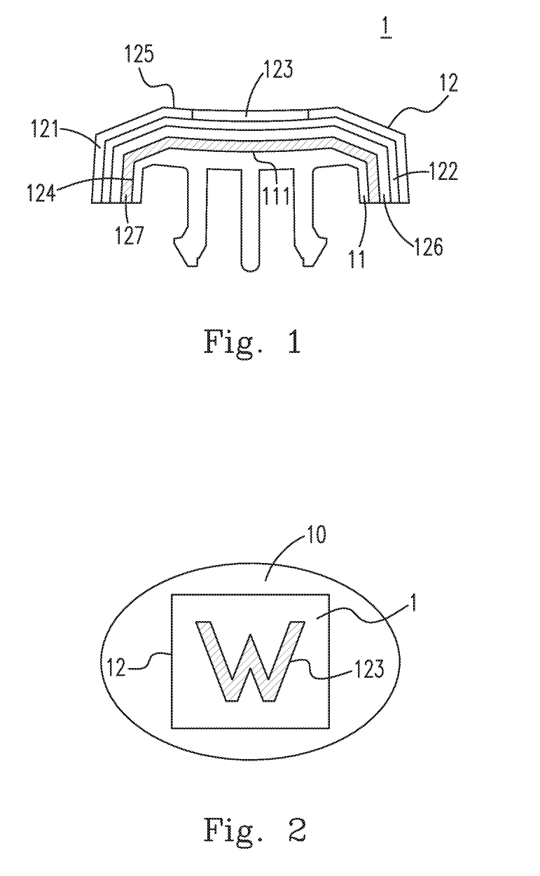

FIG. 1 shows a sectional view diagram of a keycap according to the preferred embodiment of the present invention. The capped keyboard apparatus proposed in the present invention includes plural independent keycaps and each the keycap includes a main body and a cover layer. In FIG. 1, the keycap 1 includes a main body 11 having a top surface 111 and a cover layer 12, wherein the cover layer 12 includes a shell fabric layer (or a light shield layer) 121, a base material layer (or an adhesion layer) 122, a thermoplastic layer (being of a first light divergence) 126 and an adhesive layer 127. The cover layer 12 at least covers the respective top surface 111 of the corresponding main body 11, wherein each the cover layer 12 has a lower surface 124 attached to the top surface 111 and an upper surface 125 (also an upper surface of the shell fabric layer 121), and a character (or a symbol) 123 is formed by a laser carving to fully remove the shell fabric layer 121 at the upper surface 125 whose area is vertically corresponding to that of the character 123 such that a light penetrates through the character 123. The character (or the symbol) 123 is located upon the top surface 111 when the cover layer 12 is attached to the main body 11, and the plural cover layers 12 of the keyboard are independent of one another.

The unique features of the present invention are: “After the shell fabric layer 121 goes through an alcohol abrasion test by being rubbed for at least 100 times, an abrasion test with a soft eraser by being rubbed for at least 100,000 times and an abrasion test with a hard eraser by being rubbed for at least 1,000 times, the shell fabric layer 121 is free from a peel-off (or a frame surrounding the character 123 remains intact after the three abrasion tests above).” Whether the shell fabric layer 121 can go through the three abrasion tests above without any peel-off depends on the size of the molecules, the thickness of the coating and the texture design. In general, when a molecule is larger, it is more abrasion resistant, and when the coating is thicker, it is also more abrasion resistant. For example, a skilled person in the field would know that when carbon black particles are added into the rubber to generate the reinforcing action to the rubber, the carbon black having larger particle would have better abrasion resistance. Likewise, a skilled person in the field would know that the composite floor includes transparent material (wear layer), printing shell fabric and base material. And, a thickness of the wear layer relates to the abrasion resistance of the floor. For example, plastic floor tiles with thicker wear layer have to be used in offices or entrances and exits of places with streams of people such as restaurants, department stores and storefronts in general. In addition, a skilled person in the field would know that when an automobile tire has a tread of lateral groove, its' driving force, brake force and traction force are excellent and its' abrasion resistance is good.

The alcohol abrasion test above is engaged in abrasion by using an alcohol pad, an alcohol concentration of the alcohol pad is one selected from a group consisting of 75%, 95% and 99%, the soft eraser is a CS-5 eraser, and the hard eraser is one of a EF74 eraser and a CS-10F eraser.

The alcohol abrasion test above includes a first experimental condition having a speed of 1 cycle/second, a distance of shifting back and forth of 20 mm and a load of 500 grains, and a first result of the experiment after being rubbed by an alcohol pad for at least 100 times, the shell fabric layer 121 is free from a peel-off (for example, the cover layer 12 is free from exposing the base material layer 122), a second experimental condition of the abrasion test with the soft eraser has a speed of 1 cycle/second, a distance of shifting back and forth of 20 mm, and a load of 200 grams, and a second result of the experiment after being rubbed for at least 100,000 times, the shell fabric layer 121 is free from a peel-off (for example, the cover layer 12 is free from exposing the base material layer 122), and a third experimental condition of the abrasion test with the hard eraser has a speed of 1 cycle/second, a distance of shifting back and forth of 20 mm and a load of 500 grams, and a third result of the experiment after being rubbed for at least 1,000 times, the shell fabric layer 121 is free from a peel-off (for example, the cover layer 12 is free from exposing the base material layer 122).

In FIG. 1, the shell fabric layer 121 is one selected from a group consisting of a leather, a fabric and a leatheroid, the leather has a softness, the fabric is one of a cloth with a base material of knitted fabric and a cloth processed material, and the leatheroid is one selected from a group consisting of a Polyurethane (PU) leather, a Polyvinyl Chloride (PVC) leather, a dry process PU leather of a PU shell fabric combined with a knitted fabric, a wet process PU leather of a PU shell fabric combined with a knitted fabric base, and a leatheroid of a PVC shell fabric combined with a knitted fabric.

As shown in FIG. 1, the keycap 1 includes the shell fabric layer 121 with a preferred embodiment of, for example, a PU shell fabric layer, the base material layer 122 with a preferred embodiment of, for example, a PU base material layer, the thermoplastic layer 126 with a preferred embodiment of, for example, a TPU thermoplastic layer, the adhesive layer 127 with a preferred embodiment of, for example, a PU hot melt adhesive layer. Each the cover layer 12 is formed by sequentially attaching the shell fabric layer 121, the base material layer 122, the thermoplastic layer 126 and the adhesive layer 127 from the top to the bottom.

Please refer to FIG. 1, when the keycap 1 is manufactured, the thermoplastic layer 126 included in the cover layer 12 is shaped after a heating, a vacuum forming and a cooling down, and further causes the cover layer 12 to be shaped onto the main body 11. The main body 11 and the cover layer 12 are adhesive to each other via the adhesive layer 127. The base material layer 122 is an adhesion layer to adhere together the shell fabric layer 121 and the thermoplastic layer 126. The base material layer 122 includes a transparent material, an opaque pigment and a light diffuser, the opaque pigment is mixed with the light diffuser and the transparent material in a specific mixing ratio to adjust a color of the character 123 seen by a naked eye.

FIG. 2 shows a top view diagram of a keycap of a keyboard according to the preferred embodiment of the present invention. In FIG. 2, a specific keycap 1 of a keyboard 10 has a cover layer 12, and a character (or a symbol) “W” is formed on the cover layer 12 located on top of the keycap 1 and corresponding to the top surface 111 of the main body 11 (both 111 and 11 are not shown) after the shell fabric layer 121 thereon is removed by a laser carving according to a form of the character 123.

As shown in FIG. 1, the thermoplastic layer 126 is a light divergence layer of a first light divergence to adjust a light emission color of the light. Please refer to FIG. 2, the opaque pigment or the light diffuser has an effect of a second light divergence, a light emitted out from an inner portion of keyboard apparatus 10 is scattered, refracted or reflected due to the second light divergence formed by one of the opaque pigment and the light diffuser included in the base material layer 122 such that the light appears to be a uniform light band being more uniformly. The light emission color is adjusted in response to the first and second light divergences, and due to the light going through the thermoplastic layer 126 and the base material layer 122. The adhesive layer 127 (or the cover layer 12) further includes the bottom surface 124 attached to the main body 11.

### Embodiments

1. A capped keyboard apparatus, comprising plural independent keycaps, each of which includes:
a main body; and
a cover layer covering the main body and including a shell fabric layer and a base material layer attached to the shell fabric layer, wherein a character is formed on an upper surface of the shell fabric layer, the base material layer includes a transparent material and an opaque pigment, the opaque pigment is mixed with the transparent material in a specific mixing ratio to adjust a color of the character seen by a naked eye, and a light emitted out from an inner portion of the capped keyboard apparatus is in a status being one selected from a group consisting of being scattered, refracted and reflected due to the specific mixing ratio to form a uniform light band.

2. The capped keyboard apparatus according to Embodiment 1, being used for one of a backlit keyboard and a push-button telephone keyboard, wherein the cover layers of the keycaps are independent of one another, the shell fabric layer is a light shield layer, the main body has a top surface, the character is located upon the top surface, and the shell fabric layer whose area is vertically corresponding to that of the character is fully removed by a laser carving such that the light penetrates through the character.

3. The capped keyboard apparatus according to Embodiment 1 or 2, wherein after the shell fabric layer goes through an alcohol abrasion test by being rubbed for at least 100 times, an abrasion test with a soft eraser by being rubbed for at least 100,000 times and an abrasion test with a hard eraser by being rubbed for at least 1,000 times, the cover layer is free from exposing the base material layer.

4. The capped keyboard apparatus according to any one of the above-mentioned Embodiments, wherein the alcohol abrasion test is engaged in abrasion by using an alcohol pad, an alcohol concentration of the alcohol pad is one selected from a group consisting of 75%, 95% and 99%, the soft eraser is a CS-5 eraser, and the hard eraser is one of a EF74 eraser and a CS-10F eraser.

5. The capped keyboard apparatus according to any one of the above-mentioned Embodiments, wherein a first experimental condition of the alcohol abrasion test has a speed of 1 cycle/second, a distance of shifting back and forth of 20 mm, and a load of 500 grains, a second experimental condition of the abrasion test with the soft eraser has a speed of 1 cycle/second, a distance of shifting back and forth of 20 mm, and a load of 200 grams, and a third experimental condition of the abrasion test with the hard eraser has a speed of 1 cycle/second, a distance of shifting back and forth of 20 mm, and a load of 500 grams.

6. The capped keyboard apparatus according to any one of the above-mentioned Embodiments, wherein the cover layer further includes a thermoplastic layer and an adhesive layer, the adhesive layer is configured on the main body, the thermoplastic layer is configured between the adhesive layer and the base material layer, the thermoplastic layer is shaped after a heating, a vacuum forming and a cooling down, the shaped thermoplastic layer further causes the cover layer to be shaped, the main body and the cover layer are adhesive to each other via the adhesive layer, and the base material layer is an adhesion layer to adhere together the shell fabric layer and the thermoplastic layer.

7. The capped keyboard apparatus according to any one of the above-mentioned Embodiments, wherein the thermoplastic layer is of a first light divergence to adjust a light emission color of the light, the base material layer further includes a light diffuser, one of the opaque pigment and the light diffuser has an effect of a second light divergence, the light is in the status being one selected from the group consisting of being scattered, refracted and reflected due to the second light divergence to form the uniform light band, and the light emission color is adjusted in response to the first and second light divergences.

8. The capped keyboard apparatus according to any one of the above-mentioned Embodiments, wherein the shell fabric layer is one selected from a group consisting of a leather, a fabric and a leatheroid, the leather has a softness, the fabric is one of a cloth with a base material of knitted fabric and a cloth processed material, and the leatheroid is one selected from a group consisting of a Polyurethane (PU) leather, a Polyvinyl Chloride (PVC) leather, a dry process PU leather of a PU shell fabric combined with a knitted fabric, a wet process PU leather of a PU shell fabric combined with a knitted fabric base, and a leatheroid of a PVC shell fabric combined with a knitted fabric.

9. The capped keyboard apparatus according to any one of the above-mentioned Embodiments, wherein the shell fabric layer is a PU shell fabric layer having a thickness of 0.1 mm˜0.12 mm, the base material layer is a PU base material layer having a thickness of 0.05 mm, the thermoplastic layer is a Thermoplastic Polyurethane (TPU) thermoplastic layer having a thickness of 0.1 mm, and the adhesive layer is a PU melt adhesive layer having a thickness of 0.08 mm.

10. A capped keyboard apparatus, comprising plural independent keycaps, each of which includes:
a main body; and
a cover layer covering the main body and including a shell fabric layer and a base material layer which has an opaque pigment and a light diffuser having a mixing ratio and is attached to the shell fabric layer, wherein a character is formed on an upper surface of the shell fabric layer, and a light emitted out from the capped keyboard apparatus via the character is in a status being one selected from a group consisting of being scattered, refracted and reflected according to the mixing ratio so as to form a uniform light band.

11. The capped keyboard apparatus according to Embodiment 10, wherein one of the opaque pigment and the light diffuser has an effect of light divergence.

12. A capped keyboard apparatus, comprising plural independent keycaps, each of which includes:
a main body; and
a cover layer covering the main body and including a shell fabric layer and a base material layer attached to the shell fabric layer, wherein a character is formed on an upper surface of the shell fabric layer, and a light emitted out from an interior of the cap-covered keyboard apparatus is in a status being one selected from a group consisting of being scattered, refracted and reflected and depending on the base material layer to form a uniform light band.

According to the descriptions above, the present invention discloses a capped keyboard apparatus with each of the plural keycaps configured on the keyboard having a relatively better texture and appearance than that of the keyboard apparatus in the prior art, and the relative manufacturing costs of the proposed keyboard is relatively lower than that of the backlit keyboard in the prior art because no baking varnish is required, the relative manufacturing time of the proposed keyboard is shorter than that of the backlit keyboard in the prior art, and a light emitted out from the character of the proposed keyboard is uniformly distributed, and thus has non-obviousness and novelty.

While the invention has been described in terms of what is presently considered to be the most practical and preferred embodiments, it is to be understood that the invention need not be limited to the disclosed embodiments. Therefore, it is intended to cover various modifications and similar configurations included within the spirit and scope of the appended claims, which are to be accorded with the broadest interpretation so as to encompass all such modifications and similar structures.

What is claimed is:

1. A capped keyboard apparatus, comprising plural independent keycaps, each of which includes:
a main body; and
a cover layer covering the main body and including a shell fabric layer and a base material layer attached to the shell fabric layer, wherein a character is formed on an upper surface of the shell fabric layer, the base material layer includes a transparent material and an opaque pigment, the opaque pigment is mixed with the transparent material in a specific mixing ratio to adjust a color of the character seen by a naked eye, and a light emitted out from an inner portion of the capped keyboard apparatus is in a status being one selected from a group consisting of being scattered, refracted and reflected due to the specific mixing ratio to form a uniform light band.

2. The capped keyboard apparatus according to claim 1, being used for one of a backlit keyboard and a push-button telephone keyboard, wherein the cover layers of the keycaps are independent of one another, the shell fabric layer is a light shield layer, the main body has a top surface, the character is located upon the top surface, and the shell fabric layer whose area is vertically corresponding to that of the character is fully removed by a laser carving such that the light penetrates through the character.

3. The capped keyboard apparatus according to claim 1, wherein after the shell fabric layer goes through an alcohol abrasion test by being rubbed for at least 100 times, an abrasion test with a soft eraser by being rubbed for at least 100,000 times and an abrasion test with a hard eraser by being rubbed for at least 1,000 times, the cover layer is free from exposing the base material layer.

4. The capped keyboard apparatus according to claim 3, wherein the alcohol abrasion test is engaged in abrasion by using an alcohol pad, an alcohol concentration of the alcohol pad is one selected from a group consisting of 75%, 95% and 99%, the soft eraser is a CS-5 eraser, and the hard eraser is one of a EF74 eraser and a CS-10F eraser.

5. The capped keyboard apparatus according to claim 3, wherein a first experimental condition of the alcohol abrasion test has a speed of 1 cycle/second, a distance of shifting back and forth of 20 mm, and a load of 500 grains, a second experimental condition of the abrasion test with the soft eraser has a speed of 1 cycle/second, a distance of shifting back and forth of 20 mm, and a load of 200 grains, and a third experimental condition of the abrasion test with the hard eraser has a speed of 1 cycle/second, a distance of shifting back and forth of 20 mm, and a load of 500 grains.

6. The capped keyboard apparatus according to claim 1, wherein the cover layer further includes a thermoplastic layer and an adhesive layer, the adhesive layer is configured on the main body, the thermoplastic layer is configured between the adhesive layer and the base material layer, the thermoplastic layer is shaped after a heating, a vacuum forming and a cooling down, the shaped thermoplastic layer further causes the cover layer to be shaped, the main body and the cover layer are adhesive to each other via the adhesive layer, and the base material layer is an adhesion layer to adhere together the shell fabric layer and the thermoplastic layer.

7. The capped keyboard apparatus according to claim 6, wherein the thermoplastic layer is of a first light divergence to adjust a light emission color of the light, the base material layer further includes a light diffuser, one of the opaque pigment and the light diffuser has an effect of a second light divergence, the light is in the status being one selected from the group consisting of being scattered, refracted and reflected due to the second light divergence to form the uniform light band, and the light emission color is adjusted in response to the first and second light divergences.

8. The capped keyboard apparatus according to claim 6, wherein the shell fabric layer is one selected from a group consisting of a leather, a fabric and a leatheroid, the leather has a softness, the fabric is one of a cloth with a base material of knitted fabric and a cloth processed material, and the leatheroid is one selected from a group consisting of a Polyurethane (PU) leather, a Polyvinyl Chloride (PVC) leather, a dry process PU leather of a PU shell fabric combined with a knitted fabric, a wet process PU leather of a PU shell fabric combined with a knitted fabric base, and a leatheroid of a PVC shell fabric combined with a knitted fabric.

9. The capped keyboard apparatus according to claim 8, wherein the shell fabric layer is a PU shell fabric layer having a thickness of 0.1 mm˜0.12 mm, the base material layer is a PU base material layer having a thickness of 0.05 mm, the thermoplastic layer is a Thermoplastic Polyurethane (TPU) thermoplastic layer having a thickness of 0.1 mm, and the adhesive layer is a PU hot melt adhesive layer having a thickness of 0.08 mm.

10. A capped keyboard apparatus, comprising plural independent keycaps, each of which includes:
a main body; and
a cover layer covering the main body and including a shell fabric layer and a base material layer which has an opaque pigment and a light diffuser having a mixing ratio and is attached to the shell fabric layer, wherein a character is formed on an upper surface of the shell fabric layer, and a light emitted out from the capped keyboard apparatus via the character is in a status being one selected from a group consisting of being scattered, refracted and reflected according to the mixing ratio so as to form a uniform light band.

11. The capped keyboard apparatus according to claim 10, wherein one of the opaque pigment and the light diffuser has an effect of light divergence.

12. A capped keyboard apparatus, comprising plural independent keycaps, each of which includes:
a main body; and
a cover layer covering the main body and including a shell fabric layer and a base material layer attached to the shell fabric layer, wherein a character is formed on an upper surface of the shell fabric layer, and a light emitted out from an interior of the cap-covered keyboard apparatus is in a status being one selected from a group consisting of being scattered, refracted and reflected and depending on the base material layer to form a uniform light band.
